(19) United States
(12) Patent Application Publication
(10) Pub. No.: US 2012/0155744 A1
(43) Pub. Date: Jun. 21, 2012

(54) IMAGE GENERATION METHOD

(75) Inventors: Roderick Victor Kennedy, Greater Manchester (GB); Christopher Paul Leigh, Wigan (GB)

(73) Assignee: RED CLOUD MEDIA LIMITED, Wigan (GB)

(21) Appl. No.: 13/320,163

(22) PCT Filed: May 12, 2010
(86) PCT No.: PCT/GB2010/000938

§ 371 Date: Mar. 7, 2012

(30) Foreign Application Priority Data
May 13, 2009 (GB) 0908200.9

(51) Int. Cl. G06K 9/46; G06K 9/00

(52) U.S. Cl. 382/154; 382/201

(57) ABSTRACT

A method of generating output image data representing a view from a specified spatial position in a real physical environment. The method comprises receiving data identifying the spatial position in the physical environment, receiving image data, the image data having been acquired using a first sensing modality and receiving positional data indicating positions of a plurality of objects in the real physical environment, the positional data having been acquired using a second sensing modality. At least part of the received image data is processed based upon the positional data and the data representing the specified spatial position to generate the output image data.

The present invention is concerned with a method of generating output image data representing a view from a specified spatial position in a real physical environment. The present invention is particularly, but not exclusively, applicable to methods of providing computer games, and in particular interactive driving games.

Computer implemented three dimensional simulations will be familiar to the reader. Driving games are a good example. In order to simulate the experience of driving, the user is presented on a display screen with a perspective representation of the view from a virtual vehicle. The virtual vehicle moves through a representation of a physical environment under the control of the user while the representation of the environment on the display is correspondingly updated in real time. Typically the on-screen representation is entirely computer generated, based on a stored model of the environment through which the virtual vehicle is moving. As the vehicle's position (viewpoint) in the virtual space and the direction in which it is pointing (view direction) change, the view is reconstructed, repeatedly and in real time.

Effective as computer generated images now are, there is a desire to improve the fidelity of the simulation to a real world experience. An approach which offers potential advantages in this regard is to use images taken from the real world (e.g. photographs) in place of wholly computer generated images. A photograph corresponding as closely as possible to the simulated viewpoint may be chosen from a library of photographs, and presenting a succession of such images to the user provides the illusion of moving through the real environment. Obtaining a library of photographs representing every possible viewpoint and view direction of the vehicle is not normally a practical proposition.

Typically, given a limited library of photographs, a photograph will be available which approximates but does not precisely correspond to the simulated viewpoint.

It is an object of the present invention to obviate or mitigate at least one of the problems outlined above.

According to a first aspect of the present invention, there is provided a method of generating output image data representing a view from a specified spatial position in a real physical environment, the method comprising:
receiving data identifying said spatial position in said physical environment;
receiving image data, the image data having been acquired using a first sensing modality;
receiving positional data indicating positions of a plurality of objects in said real physical environment, said positional data having been acquired using a second sensing modality;
processing at least part of said received image data based upon said positional data and said data representing said specified spatial position to generate said output image data.

There is therefore provided a method whereby data about the physical environment is received which has been acquired using different sensing modalities and in particular, positional data acquired using a second sensing modality is received. There is therefore no need to calculate positional data from the image data acquired using the first sensing modality, improving the efficiency and accuracy of the method. The received positional data allows the received image data to be processed to present a view of the physical environment from the specified spatial position.

The second sensing modality may comprise active sensing and the first sensing modality may comprise passive sensing. That is, the second sensing modality may comprise emitting some form of radiation and measuring the interaction of that radiation with the physical environment. Examples of active sensing modalities are RAdio Detection And Ranging (RADAR) and Light Detecting And Ranging (LiDAR) devices. The first sensing modality may comprise measuring the effect of ambient radiation on the physical environment. For example, the first sensing modality may be a light sensor such as a charge coupled device (CCD).

The received image data may comprise a generally spherical surface of image data. It is to be understood that by generally spherical, it is meant that the received image data may define a surface of image data on the surface of sphere. The received image data may not necessarily cover a full sphere, but may instead only cover part (for example 80%) of a full sphere, and such a situation is encompassed by reference to “generally spherical”. The received image data may be generated from a plurality of images, each taken from a different direction from the same spatial location, and combined to form the generally spherical surface of image data.

The method may further comprise receiving a view direction, and selecting a part of the received image data, the part representing a field of view based upon (e.g. centred upon) said view direction. The at least part of the image data may be the selected part of the image data.

The received image data may be associated with a known spatial location from which the image data was acquired.

Processing at least part of the received image data based upon the positional data and the data representing the spatial position to generate the output image data may comprise: generating a depth map from the positional data, the depth map comprising a plurality of distance values, each of the distance values representing a distance from the known spatial location to a point in the real physical environment. That is, the positional data may comprise data indicating the positions (which may be, for example, coordinates in a global coordinate system) of objects in the physical environment. As the positions of the objects are known, the positional information can be used to determine the distances of those objects from the known spatial location.

The at least part of the image data may comprise a plurality of pixels, the value of each pixel representing a point in the real physical environment visible from the known spatial location. For example, the value of each pixel may represent characteristics of a point in the real physical environment such as a material present at that point, and lighting conditions incident upon that point. For a particular pixel in the plurality of pixels, a corresponding depth value in the plurality of distance values represents a distance from the known spatial location to the point in the real physical environment represented by that pixel.

The plurality of pixels may be arranged in a pixel matrix, each element of the pixel matrix having associated coordinates. Similarly, the plurality of depth values may be arranged in a depth matrix, each element of the depth matrix having associated coordinates, wherein a depth value corresponding to a particular pixel located at particular coordinates in the pixel matrix is located at the particular coordinates in the depth matrix. That is, the values in the pixel matrix and the values in the depth matrix may have a one-to-one mapping.

Processing at least part of the received image data may comprise, for a first pixel in the at least part of the image data, using the depth map to determine a first vector from the known spatial location to a point in the real physical environment represented by the first pixel; processing the first vector to determine a second vector from the known spatial location wherein a direction of the second vector is associated with a second pixel in the at least part of the received image data, and setting a value of a third pixel in the output image data based upon a value of the second pixel, the third pixel and the first pixel having corresponding coordinates in the output image data and the at least part of the received image data respectively. Put another way, the first and second pixels are pixels in the at least part of the received image data, while the third pixel is a pixel in the output image. The value of the third pixel is set based upon the value of the second pixel, and the second pixel is selected based upon the first vector.

The method may further comprise iteratively determining a plurality of second vectors from the known spatial location wherein the respective directions of each of the plurality of second vectors is associated with a respective second pixel in the at least part of the received image. The value of the third pixel may be set based upon the value of one of the respective second pixels. For example, the value of the third pixel may be based upon the second pixel which most closely matches some predetermined criterion.

The received image data may be selected from a plurality of sets of image data, the selection being based upon the received spatial location. The plurality of sets of image data may comprise images of the real physical environment acquired at a first plurality of spatial locations. Each of the plurality of sets of image data may be associated with a respective known spatial location from which that image data was acquired. In such a case, the received image data may be selected based upon a distance between the received spatial location and the known spatial location at which the received image data was acquired.

The known location may be determined from a time at which that image was acquired by an image acquisition device and a spatial location associated with the image acquisition device at the time. The time may be a GPS time.

The positional data may be generated from a plurality of depth maps, each of the plurality of depth maps acquired by scanning the real physical environment at respective ones of a second plurality of spatial locations.

The first plurality locations may be located along a track in the real physical environment.

According to a second aspect of the present invention, there is provided apparatus for generating output image data representing a view from a specified spatial position in a real physical environment, the apparatus comprising:
means for receiving data identifying said spatial position in said physical environment;
means for receiving image data, the image data having been acquired using a first sensing modality;
means for receiving positional data indicating positions of a plurality of objects in said real physical environment, said positional data having been acquired using a second sensing modality;
means for processing at least part of said received image data based upon said positional data and said data representing said specified spatial position to generate said output image data.

According to a third aspect of the present invention, there is provided a method of acquiring data from a physical environment, the method comprising:
acquiring, from said physical environment, image data using a first sensing modality;
acquiring, from said physical environment, positional data indicating positions of a plurality of objects in said physical environment using a second sensing modality;
wherein said image data and said positional data have associated location data indicating a location in said physical environment from which said respective data was acquired so as to allow said image data and said positional data to be used together to generate modified image data.

The image data and the positional data may be configured to allow generation of image data from a specified location in the physical environment.

Acquiring positional data may comprise scanning said physical environment at a plurality of locations to acquire a plurality of depth maps, each depth map indicating the distance of objects in the physical environment from the location at which the depth map is acquired, and processing said plurality of depth maps to create said positional data.

According to a fourth aspect of the present invention, there is provide apparatus for acquiring data from a physical environment, the method comprising:
means for acquiring, from said physical environment, image data using a first sensing modality;
means for acquiring, from said physical environment, positional data indicating positions of a plurality of objects in said physical environment using a second sensing modality;
wherein said image data and said positional data have associated location data indicating a location in said physical environment from which said respective data was acquired so as to allow said image data and said positional data to be used together to generate modified image data.

According to a fifth aspect of the invention, there is provided a method for processing a plurality of images of a scene. The method comprises selecting a first pixel of a first image, said first pixel having a first pixel value; identifying a point in said scene represented by said first pixel; identifying a second pixel representing said point in a second image, said second pixel having a second pixel value; identifying a third pixel representing said point in a third image, said third pixel having a third pixel value; determining whether each of said first pixel value, said second pixel value and said third pixel value satisfy a predetermined criterion; and if one of said first pixel value, said second pixel value and said third pixel value do not satisfy said predetermined criterion, modifying said one of said pixel values based upon values of others of said pixel values.

In this way, where a particular point in a scene is represented by pixels in a plurality of images, the images can be processed so as identify any image which a pixel value of a pixel representing the point has a value which is significantly different from the pixel values of pixels representing the particular point in other images. In this way, where a pixel representing the point has a value caused by some moving object, the effect of that moving object can be mitigated.

The predetermined criterion may specify allowable variation between said first, second and third pixel values. For example, the predetermined criterion may specify a range within which said first, second and third pixel values should lie, such that if one of said first second and third pixel values does not lie within that range, the pixel value not lying within that range is modified.

Modifying said one of said pixel values based upon values of others of said pixel values may comprises replacing said one of said pixel values with a pixel value based upon said others of said pixel values, for example a pixel value which is an average of said others of said pixel values. Alternatively, the modifying may comprise replacing said one of said pixel values with the value of one of the others of said pixel values.

The method of the fifth aspect of the invention may be used to pre-process image data which is to be used in methods according to other aspects of the invention.

It will be appreciated that aspects of the invention can be implemented in any convenient form. For example, the invention may be implemented by appropriate computer programs which may be carried out appropriate carrier media which may be tangible carrier media (e.g. disks) or intangible carrier media (e.g. communications signals). Aspects of the invention may also be implemented using suitable apparatus which may take the form of programmable computers running computer programs arranged to implement the invention.

It will be further appreciated that features described in the context of one aspect of the invention can be applied to other aspects of the invention. Similarly, the various aspects of the invention can be combined in various ways.

There is further provided a method of simulating a physical environment on a visual display, the method comprising (a) a data acquisition process and (b) a display process for providing on the visual display a view from a movable virtual viewpoint, wherein:

the data acquisition process comprises photographing the physical environment from multiple known locations to create a library of photographs and also scanning the physical environment to establish positional data of features in the physical environment,

the display process comprises selecting one or more photographs from the library, based on the virtual position of the viewpoint, blending or interpolating between them, and adjusting the blended photograph, based on an offset between the known physical locations from which the photographs were taken and the virtual position of the viewpoint, and using the positional data, to provide on the visual display a view which approximates to the view of the physical environment from the virtual viewpoint. It is also possible to perform the adjustment and blending in the opposite order.

If the virtual viewpoint were able to move arbitrarily in the three dimensional virtual environment, the number of images required might prove excessive.

The inventors have recognised that where movement of the virtual viewpoint is limited to being along a line, the number of images required is advantageously reduced. For example, in simulations such as driving games, in which the path of the observer and the direction of his view are constrained, can be implemented using a much smaller data set. Preferably, the photographs are taken from positions along a line in the physical environment. The line may be the path of a vehicle (carrying the imaging apparatus used to take the photographs) through the physical environment. In the case of a driving game, the line will typically lie along a road. Because the photographs will then be in a linear sequence and each photograph will be similar to some extent to the previous photograph, it is possible to take advantage of compression algorithms such as are used for video compression.

Correspondingly, during the display process, the viewpoint may be represented as a virtual position along the line and a virtual offset from it, the photographs selected for display being the ones taken from the physical locations closest to the virtual position of the viewpoint along the line.

The positional data may be obtained using a device which detects distance to an object along a line of sight. A light detection and ranging (LiDAR) device is suitable, particularly due to its high resolution, although other technologies including radar or software might be adopted in other embodiments.

Preferably, distance data from multiple scans of the physical environment is processed to produce positional data in the form of a ‘point cloud’ representing the positions of the detected features of the physical environment. In this case a set of depth images corresponding to the photographs can be generated, and the display process involves selecting the depth images corresponding to, the selected photographs.

Preferably the adjustment of the photograph includes depth-image-based rendering, whereby the image displayed in the view is generated by selecting pixels from the photograph displaced through a distance in the photograph which is a function of the aforementioned offset and of the distance of the corresponding feature in the depth image. Pixel displacement is preferably inversely proportional to the said distance. Also pixel displacement is preferably proportional to the length of the said offset. Pixel displacement may be calculated by an iterative process.

The is further provided a method of acquiring data for simulating a physical environment, the method comprising mounting on a vehicle (a) an imaging device for taking photographs of the physical environment, (b) a scanning device for measuring the distance of objects in the physical environment from the vehicle, and (c) a positioning system for determining the vehicle's spatial location and orientation, the method comprising moving the vehicle through the physical environment along a line approximating the expected path of a movable virtual viewpoint, taking photographs of the physical environment at spatial intervals to create a library of photographs taken at locations which are known from the positioning system, and also scanning the physical environment at spatial intervals, from locations which are known from the positioning system, to obtain data representing locations of features in the physical environment.

Preferably the positioning system is a Global Positioning System (GPS).

Preferably the scanning device is a light detection and ranging device.

Preferably the device for taking photographs acquires images covering all horizontal directions around the vehicle.

There is further provided a vehicle for acquiring data for simulating a physical environment, the vehicle comprising (a) an imaging device for taking photographs of the physical environment, (b) a scanning device for measuring the distance of objects in the physical environment from the vehicle, and (c) a positioning system for determining the vehicle's spatial location and orientation, the vehicle being movable through the physical environment along a line approximating the expected path of a movable virtual viewpoint, and being adapted to take photographs of the physical environment at spatial intervals to create a library of photographs taken at locations which are known from the positioning system, and to scan the physical environment at spatial intervals, from locations which are known from the positioning system, to obtain data representing locations of features in the physical environment.

It will be further appreciated that features described in the context of one aspect of the invention can be applied to other aspects of the invention. Similarly, the various aspects of the invention can be combined in various ways.

Embodiments of the present invention will now be described, by way of example only, with reference to the accompanying drawings, in which:

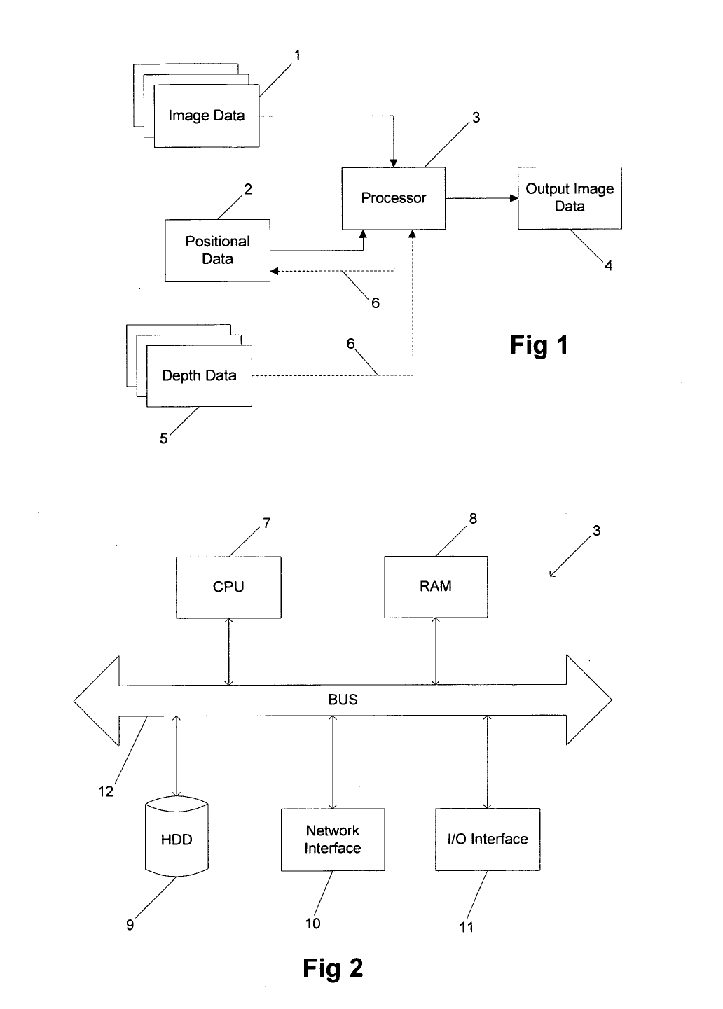

FIG. 1 is a schematic illustration of processing carried out in an embodiment of the invention;

FIG. 2 is a schematic illustration showing the processor of FIG. 1, in the form of a computer, in further detail;

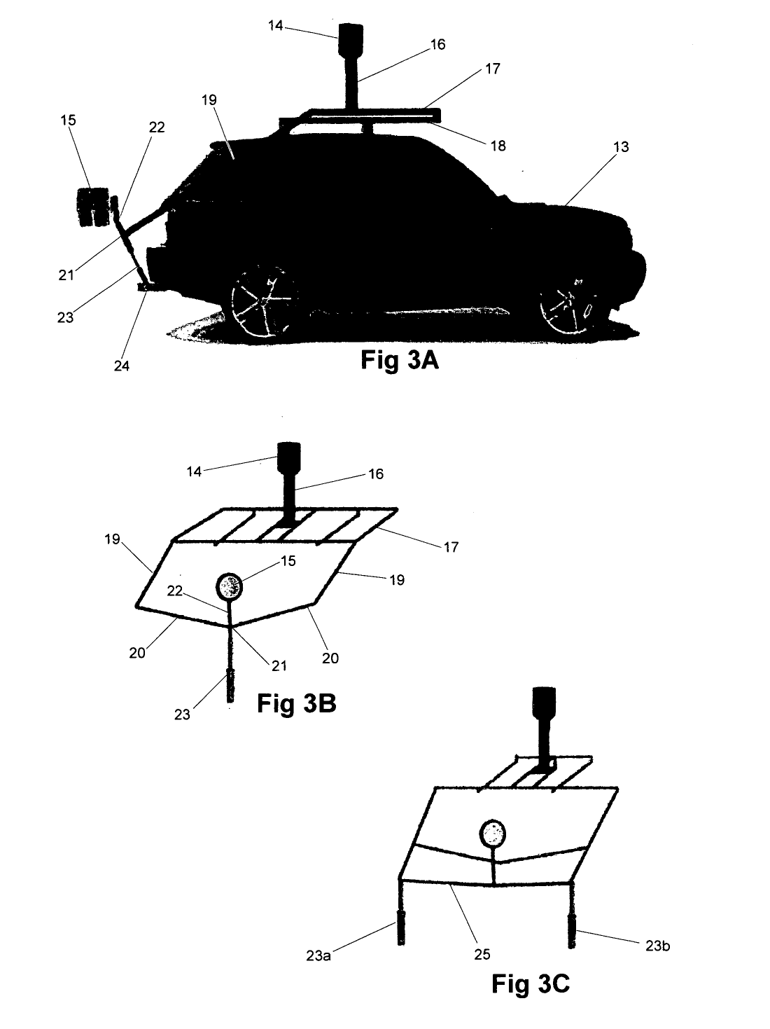

FIG. 3A is an image of a data acquisition vehicle arranged to collect data used in the processing of FIG. 1;

FIG. 3B is an illustration of a frame mounted on the data acquisition vehicle of FIG. 3A;

FIG. 3C is an illustration of an alternative embodiment of the frame of FIG. 3B;

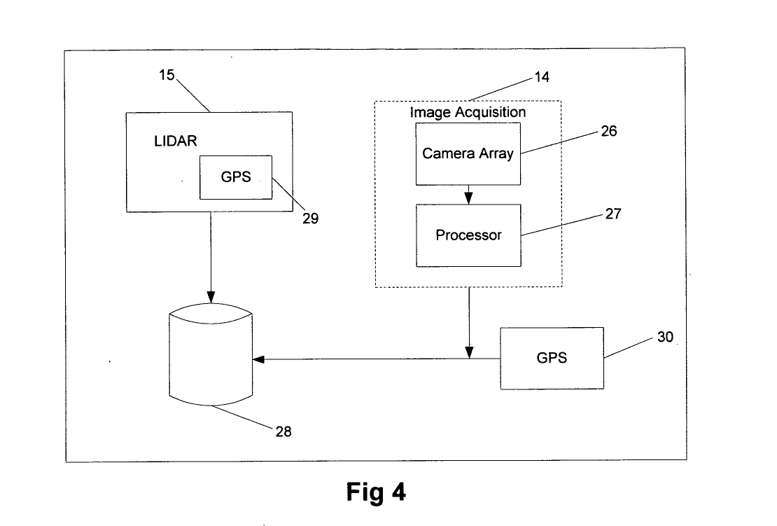

FIG. 4 is a schematic illustration of data acquisition equipment mounted on board the data acquisition vehicle of FIG. 3A;

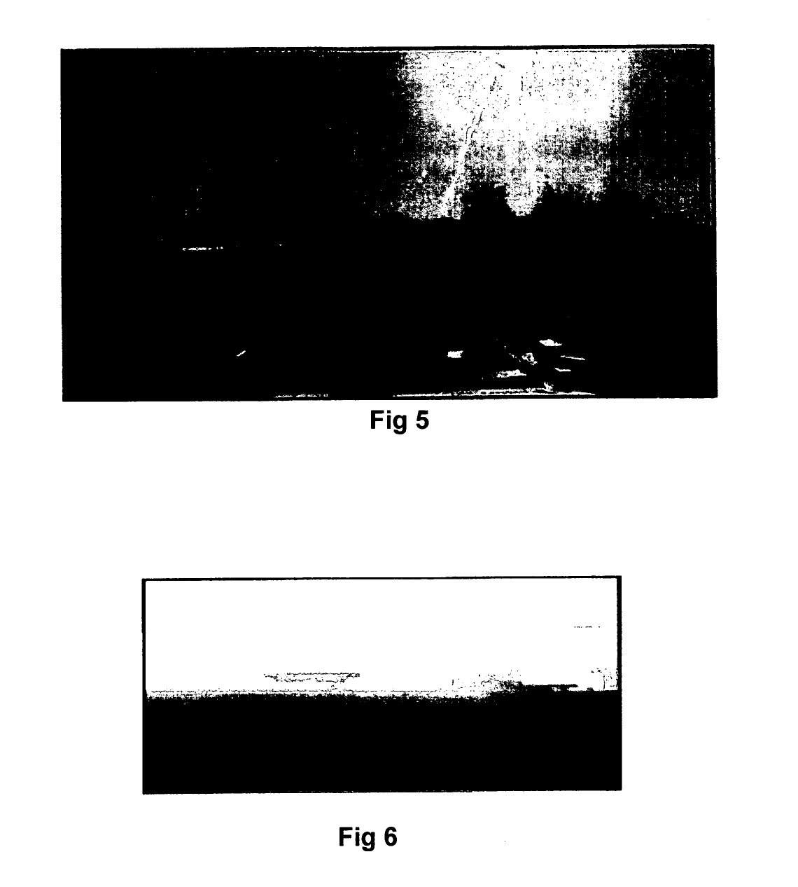

FIG. 5 is an input image used in the processing of FIG. 1;

FIG. 6 is a visual representation of depth data associated with an image and used in the processing of FIG. 1;

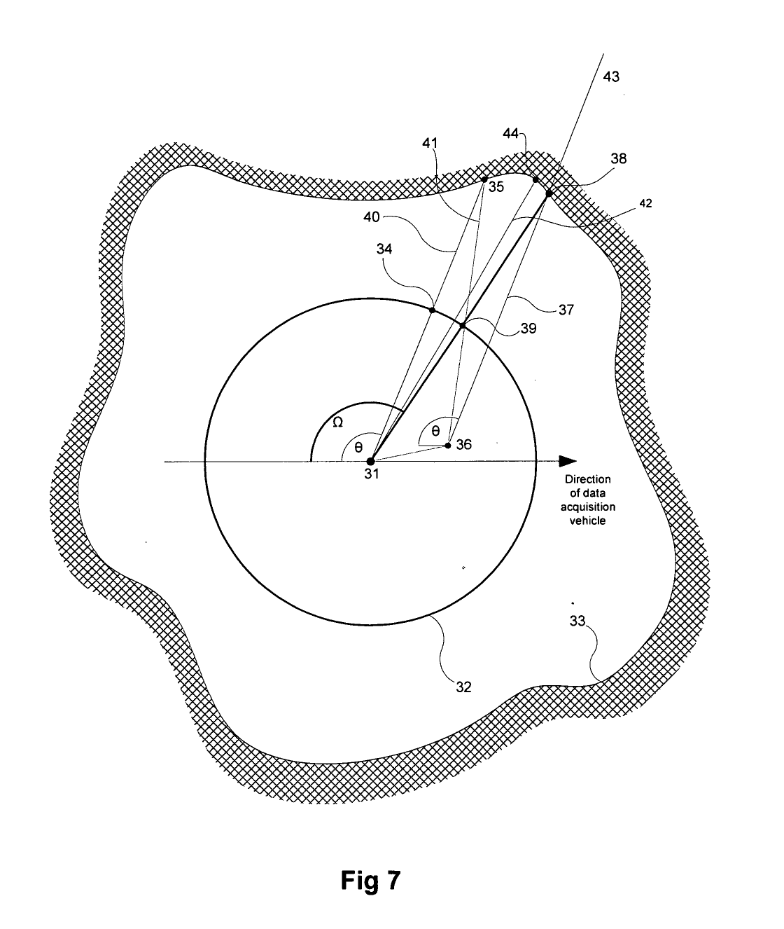

FIG. 7 is a schematic illustration, in plan view, of locations in an environment relevant to the processing of FIG. 1;

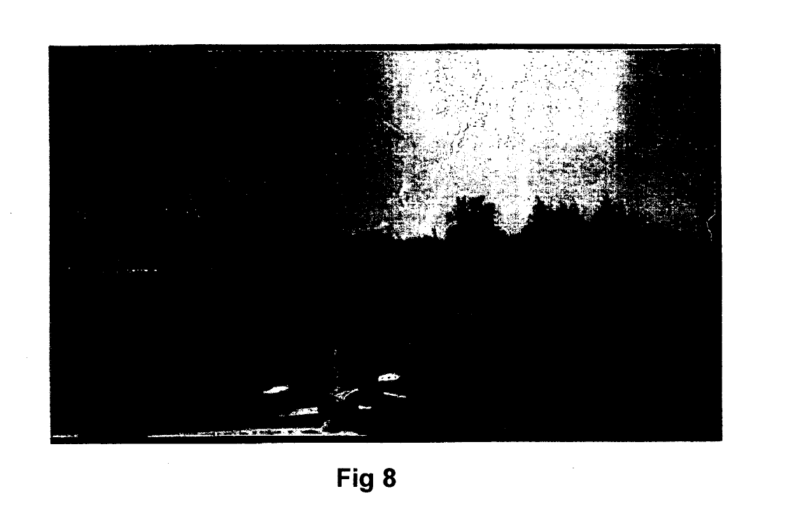

FIG. 8 is an image which is output from the processing of FIG. 1;

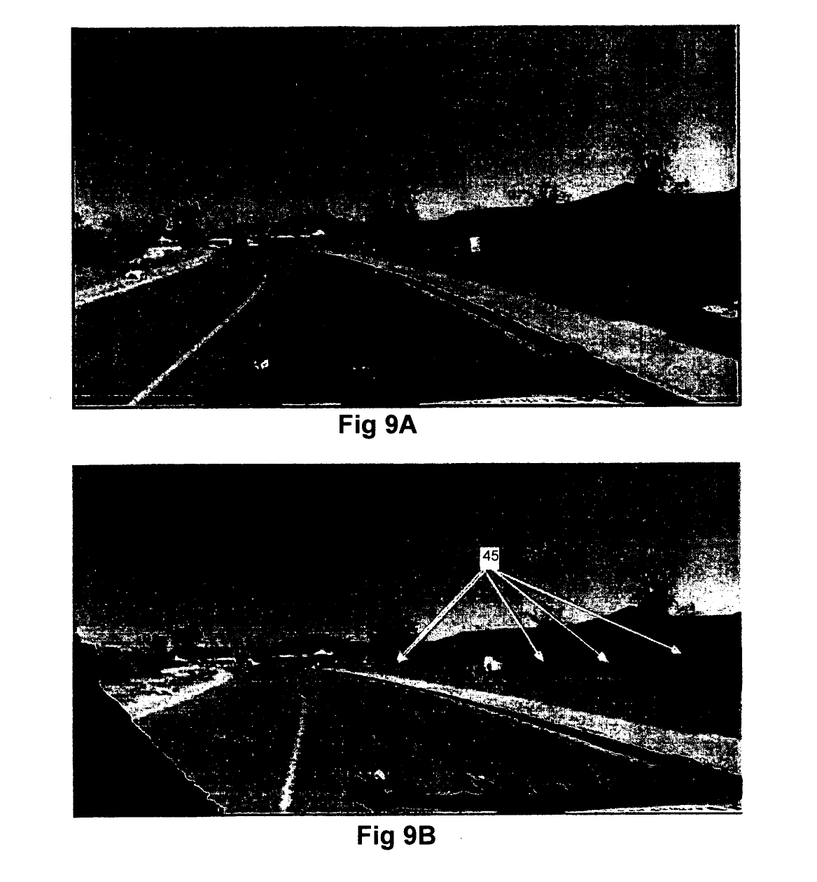

FIGS. 9A and 9B are images showing artefacts caused by occlusion; and

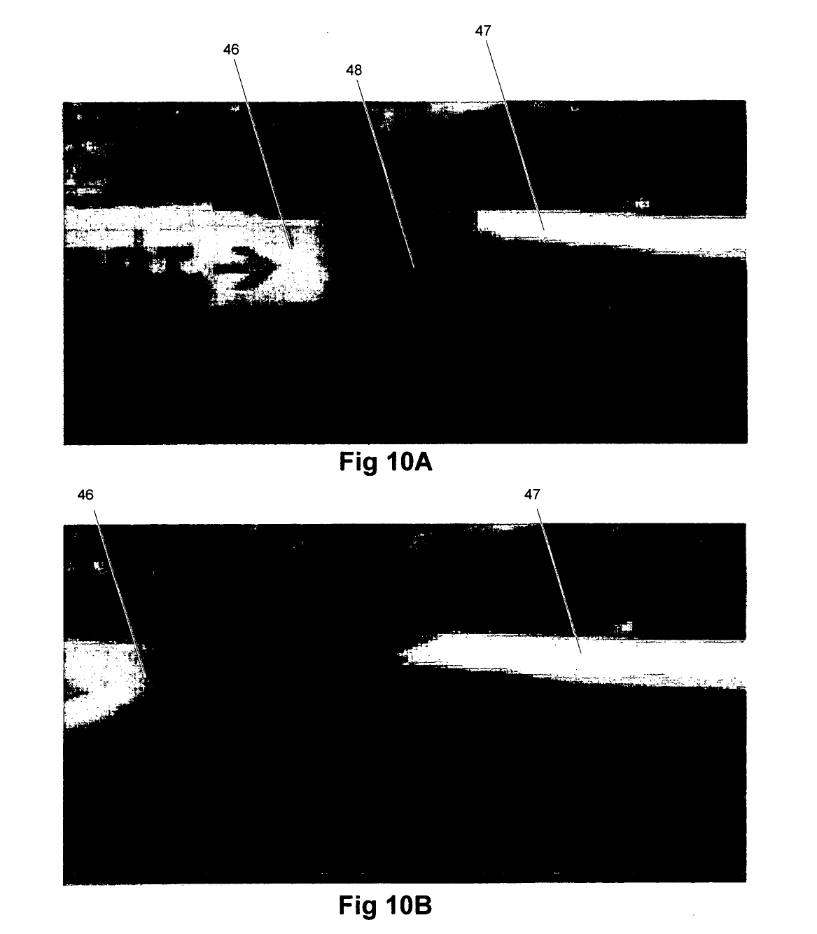

FIGS. 10A and 10B are images showing an approach to mitigating the effects of occlusion of the type shown in FIGS. 9A and 9B.

FIG. 1 provides an overview of processing carried out in an embodiment of the invention. Image data 1 and positional data 2 are input to a processor 3. The image data comprises a plurality of images, each image having been generated from a particular point in a physical environment of interest. The positional data indicates the positions of physical objects within the physical environment of interest. The processor 3 is adapted (by running appropriate computer program code) to select one of the images included in the image data 1 and process the selected image based upon the positional data 2 to generate output image data 4, the output image data 4 representing an image as seen from a specified position within the physical environment. In this way, the processor 3 is able to provide output image data representing an image which would be seen from a position within the physical environment for which no image is included in the image data 1.

The positional data 2 is generated from a plurality of scans of the physical environment, referred to herein as depth scans. Such scans generate depth data 5. The depth data 5 comprises a plurality of depth scans, each depth scan 5 providing the distances to the nearest physical objects in each direction from a point from which the depth scan is generated. The depth data 5 is processed by the processor 3 to generate the positional data 2, as indicated by a pair of arrows 6.

The processor 3 can take the form of a personal computer. In such a case, the processor 3 may comprise the components shown in FIG. 2. The computer 3 comprises a central processing unit (CPU) 7 which is arranged to execute instructions which are read from volatile storage in the form of RAM 8. The RAM 8 also stores data which is processed by the executed instructions, which comprises the image data 1 and the positional data 2. The computer 3 further comprises non-volatile storage in the form of a hard disk drive 9. A network interface 10 allows the computer 3 to connect to a computer network so as to allow communication with other computers, while an I/O interface 11 allows for communication with suitable input and output devices (e.g. a keyboard and mouse, and a display screen). The components of the computer are connected together by a communications bus 12.

Some embodiments of the invention are described in the context of a driving game in which a user moves along a representation of predefined track which exists in the physical environment of interest. As the user moves along the representation of the predefined track he or she is presented with images representing views of the physical environment seen from the user's position on that predefined track, such images being output image data generated as described with reference to FIG. 1.

In such a case, data acquisition involves a vehicle travelling along a line defined along the predefined track in the physical environment, and obtaining images at known spatial locations using one or more cameras mounted on the vehicle. Depth data, representing the spatial positions of features in the physical environment, is also acquired as the vehicle travels along the line. Acquisition of the images and depth data may occur at the same time, or may at distinct times. During subsequent creation of the output image data, typically, two images are chosen from the acquired sequence of images by reference to the user's position on a representation of the track. These two images are manipulated, in the manner to be described below, to allow for the offset of the user's position on the track from the positions from which the images were acquired.

The process of data acquisition in the context of generating images representing views from various positions along a track will now be described. It should be understood that, while the described process and apparatus provide a convenient and efficient way to obtain the necessary data, the data can be obtained using any suitable means.

Data acquisition is carried out by use of a data acquisition vehicle 13 shown in side view in FIG. 3A. The data acquisition vehicle 13 is provided with an image acquisition device 14 configured to obtain images of the physical environment surrounding the data acquisition vehicle 13. In the present embodiment, the image acquisition device 14 comprises six digital video cameras covering a generally spherical field of view around the vehicle. It is to be understood that by generally spherical, it is meant that the images taken by the image acquisition device 14 define a surface of image data on the surface of sphere. The image data may not necessarily cover a full sphere, but may instead only cover part (for example 80%) of a full sphere. In particular, it will be appreciated that the image acquisition device 14 is not be able to obtain images directly below the point at which the image acquisition device 4 is mounted (e.g. points below the vehicle 13). However the image acquisition device 14 is able to obtain image data in all directions in a plane in which the vehicle moves. The image acquisition device 14 is configured to obtain image data approximately five to six times per second at a resolution of 2048 by 1024 pixels. An example of a suitable image acquisition device is the Ladybug3 spherical digital camera system from Point Grey Research, Inc of Richmond, BC, Canada, which comprises six digital video cameras as described above.

The data acquisition vehicle 13 is further provided with an active scanning device 15, for obtaining depth data from the physical environment surrounding the data acquisition vehicle 13. Each depth scan generates a spherical map of depth points centred on the point from which that scan is taken (i.e. the point at which the active scanning device 15 is located). In general terms, the active scanning device 15 emits some form of radiation, and detects an interaction (for example reflection) between that radiation and the physical environment being scanned. It can be noted that, in contrast, passive scanning devices detect an interaction between the environment and ambient radiation already present in the environment. That is, a conventional image sensor, such as a charge coupled device, could be used as a passive scanning device.

In the present embodiment the scanning device 15 takes the form of a LiDAR (light detection and ranging) device, and more specifically a 360 degree scanning LiDAR. Such devices are known and commercially available. LiDAR devices operate by projecting focused laser beams along each of a plurality of a controlled directions and measuring the time delay in detecting a reflection of each laser beam to determine the distance to the nearest object in each direction in which a laser beam is projected. By scanning the laser through 360 degrees, a complete set of depth data, representing the distance to the nearest object in all directions from the active scanning device 15, is obtained. The scanning device 15 is configured to operate at the same resolution and data acquisition rate as the camera 14. That is, the scanning device 15 is configured to obtain a set of 360 degree depth data approximately five to six times a second at a resolution equal to that of the acquired images.

It can be seen from FIG. 3A that the image acquisition device 14 is mounted on a pole 16 which is attached to a frame 17. The frame 17 is shown in further detail in FIG. 3B which provides a rear perspective view of the frame 17. The frame 17 comprises an upper, substantially flat portion, which is mounted on a roof rack 18 of the data acquisition vehicle 13. The pole 16 is attached to the upper flat portion of the frame 17. Members 19 extend downwardly and rearwardly from the upper flat portion, relative to the data acquisition vehicle 13. Each of the members 19 is connected to a respective member 20, which extends downwardly and laterally relative to the data acquisition vehicle 13, the members 20 meeting at a junction 21. The scanning device 15 is mounted on a member 22 which extends upwardly from the junction 21. A member 23 connects the member 22 to a plate 24 which extends rearwardly from the data acquisition vehicle 13. The member 23 is adjustable so as to aid fitting of the frame 17 to the data acquisition vehicle 13.

FIG. 3C shows an alternative embodiment of the frame 17. It can be seen that the frame of FIG. 3C comprises two members 23a, 23b which correspond to the member 23 of FIG. 3B. Additionally it can be seen that the frame of FIG. 3C comprises a laterally extending member 25 from which the members 23a, 23b extend.

FIG. 4 schematically shows components carried on board the data acquisition vehicle 13 to acquire the data described above. It can be seen that, as mentioned above, the image acquisition device 14 comprises a camera array 26 comprising six video cameras, and a processor 27 arranged to generate generally spherical image data from images acquired by the camera array 26. Image data acquired by the image data acquisition device 14, and positional data acquired by the active scanning device 15 are stored on a hard disk drive 28.

The data acquisition vehicle 13 is further provided with a positioning system which provides the spatial location and orientation (bearing) of the data acquisition vehicle 13. For example, a suitable positioning system may be a combined inertial and satellite navigation system of a type well known in the art. Such a system may have an accuracy of approximately two centimetres. Using the positioning system, each image and each set of depth data can be associated with a known spatial location in the physical environment.

As shown in FIG. 4, the positioning system may comprise separate positioning systems. For example, the scanning device 15 may comprise an integrated GPS receiver 29, such that for each depth scan, the GPS receiver 29 can accurately provide the spatial position at the time of that depth scan. The image acquisition device does not comprise an integrated GPS receiver. Instead, a GPS receiver 30 is provided on board the data acquisition vehicle 13 and image data acquired by the image acquisition device 14 is associated with time data generated by the GPS receiver 30 when the image data is acquired. That is, each image is associated with a GPS time (read from a GPS receiver). The GPS time associated with an image can then be correlated with a position of the data acquisition vehicle at that GPS time and can thereby be used to associate the image with the spatial position at which the image was acquired. The position of the data acquisition vehicle 13 may be measured at set time points by the GPS receiver 30, and a particular LiDAR scan may occur between those time points such that position data is not recorded by the GPS receiver 30 at the exact time of a LiDAR scan. By associating each LiDAR scan with a GPS time at which it is made, and having knowledge of the GPS time associated with each item of position data recorded by the GPS receiver 30, the position of the data acquisition vehicle 13 at the time of a particular LiDAR scan can be interpolated from the position data measured by the GPS receiver 30 at the set time points at which the GPS receiver measured the position of the data acquisition vehicle 13.

The data acquisition vehicle 13 is driven along the predefined track at a speed of approximately ten to fifteen miles per hour, the image acquisition device 14 and the scanning device 15 capturing data as described above. The data acquisition process can be carried out by traversing the predefined track once, or several times along different paths along the predefined track to expand the bounds of the data gathering. The data acquisition vehicle 13 may for example be driven along a centre line defined along the predefined track.

Data acquisition in accordance with the present invention can be carried out rapidly. For example, data for simulating a particular race track could be acquired shortly before the race simply by having the data acquisition vehicle 2 slowly complete a circuit of the track. In some cases more than one pass may be made at different times, e.g. to obtain images under different lighting conditions (day/night or rain/clear, for example).

In principle it is possible to associate a single depth scan generated from a spatial position with an image generated from the same spatial position, and to use the two together to produce output image data. In such a case, the depth data is in a coordinate system defined with reference to a position of the data acquisition vehicle. It will be appreciated that, as the image acquisition device 14 and the scanning device 15 acquire data at the same resolution, each pixel in an acquired image, taken at a particular spatial position, will have a corresponding depth value in a depth scan taken at the same geographical location.

Where depth data and image data are in a coordinate system defined with reference to a position of the data acquisition vehicle, a user's position on the track can be represented as a distance along the path travelled by the data acquisition vehicle 13 together with an offset from that path. The user's position on the track from which an image is to be generated can be anywhere, provided that it is not so far displaced from that path that distortion produces unacceptable visual artefacts. The user's position from which an image is to be generated can, for example, be on the path taken by the data acquisition vehicle B.

It will be appreciated that associating a single depth scan with an image requires that image data and depth data are acquired from spatially coincident (or near coincident) locations, and is therefore somewhat limiting.

In preferred embodiments, multiple depth scans are combined in post acquisition processing to create a point cloud, each depth scan having been generated from an associated location within the physical environment of interest. That is, each depth scan acquired during the data acquisition process is combined to form a single set of points, each point representing a location in a three-dimensional fixed coordinate system (for example, the same fixed coordinate system used by the positioning system). In more detail, the location, in the fixed coordinate system at which a particular depth scan was acquired is known and can therefore be used to calculate the location, in the fixed coordinate system, of the locations of objects detected in the environment by that depth scan. By combining such data from a plurality of depth scans a single estimate of the location of objects in the environment can be generated.

Combination of multiple depth scans in the manner described above allows a data set to be defined which provides a global estimate of the location of all objects of interest in the physical environment. Such an approach allows one to easily determine the distance of objects in the environment relative to a specified point in the fixed coordinate system from which it is desired to generate an image representing a view from the point. Such an approach also obviates the need for synchronisation between the locations at which depth data is captured, and the locations at which image data is captured. Assuming that the locations from which image data is acquired in the fixed coordinate system are known, the depth data can be used to manipulate the image data.

Indeed, once a single point cloud has been defined, an individual depth map can be generated for any specified location defined with reference to the fixed coordinate system within the point cloud, the individual depth map representing features in the environment surrounding the specified location. A set of data representing a point cloud of the type described above is referred to herein as positional data, although it will be appreciated that in alternative embodiments positional data may take other forms.

It has been explained that each acquired image is generally spherical. By this it is meant that the image defines a surface which defines part of a sphere. Any point (e.g. a pixel) on that sphere can be defined by the directional component of a vector originating at a point from which the image was generated and extending through the point on the sphere. The directional component of such a vector can be defined by a pair of angles. A first angle may be an azimuth defined by projecting the vector into the (x,y) plane and taking an angle of the projected vector relative to a reference direction (e.g. a forward direction of the data acquisition vehicle). A second angle may be an elevation defined by an angle of the vector relative to the (x,y) plane.

Pixel colour and intensity at a particular pixel of an acquired image are determined by the properties of the nearest reflecting surface along a direction defined by the azimuth and elevation associated with that pixel. Pixel colour and intensity are affected by lighting conditions and by the nature of the intervening medium (the colour of distant objects is affected by the atmosphere through which the light passes).

A single two dimensional image may be generated from the generally spherical image data acquired from a particular point by defining a view direction angle at that point, and generating an image based upon the view direction angle. In more detail, the view direction has azimuthal and elevational components. A field of view angle is defined for each of the azimuthal and elevational components so as to select part of the substantially spherical image data, the centre of the selected part of the substantially spherical image data being determined by view direction; an azimuthal extent of the selected part being defined by a field of view angle relative to the azimuthal component of the view direction, and an elevational extent of the selected part being defined by a field of view angle relative to the elevational component of the view direction. The field of view angles applied to the azimuthal and elevational components of the view direction may be equal or different. It will be appreciated that selection of the field of view angle(s) will determine how much of the spherical image data is included in the two dimensional image. An example of such a two dimensional image is shown in FIG. 5.

It will now be explained how a view from a specified location is generated from the acquired image data and positional data.

In order to generate an image of the physical environment of interest from a specified location in the physical environment (referred to herein to as the chosen viewpoint) and in a specified view direction, image data which was acquired at a location (from herein referred to as the camera viewpoint) near to the chosen viewpoint is obtained, and manipulated based upon positional data having the form described above. The obtained image data is processed with reference to the specified view direction and one or two angles defining a field of view in the manner described above, so as to define a two dimensional input image. For the purposes of example, it can be assumed that the input image is that shown in FIG. 5.

The positional data is processed to generate a depth map representing distances to objects in the physical environment from the point at which the obtained image data was acquired. The depth map is represented as a matrix of depth values, where coordinates of depth values in the depth map have a 1-to-1 mapping with the coordinates of pixels in the input image. That is, for a pixel at a given coordinates in the input image, the depth (from the camera viewpoint) of the object in the scene represented by that pixel is given by the value at the corresponding coordinates in the depth map. FIG. 6 is an example of an array of depth values shown as an image.

FIG. 7 shows a cross section through the physical environment along a plane in which the data acquisition vehicle travels, and shows the location of various features which are relevant to the manipulation of an input image

The camera viewpoint is at 31. Obtained image data 32 generated by the image acquisition device is shown centred on the camera viewpoint 31. As described above, the input image will generally comprise a subset of the pixels in the obtained image data 32. A scene 33 (being part of the physical environment) captured by the image acquisition device is shown, and features of this scene determine the values of pixels in the obtained image data 32.

A pixel 34 in the obtained image data 32 in a direction θ from the camera viewpoint 31 represents a point 35 of the scene 33 located in the direction θ, where θ is a direction within a field of view of the output image. It should be noted that although a pixel in the direction θ is chosen by way of example in the interests of simplicity, any pixel in a direction within the field of view could similarly have been chosen. As described above, the direction corresponding with a particular pixel can be represented using an azimuth and an elevation. That is, the direction θ has an azimuthal and an elevational component.

The chosen viewpoint, from which it is desired to generate a modified image of the scene 33 in the direction θ, is at 36. It can be seen that a line 37 from the chosen viewpoint 36 in the direction θ intersects a point 38 in the scene 33. It is therefore desirable to determine which pixel in the input image represents the point 38 in the scene 33. That is, it is desired to determine a direction Ω from the camera viewpoint 31 that intersects a pixel 39 in the input image, the pixel 39 representing the point 38 in the scene 33.

Calculation of the direction Ω is now described with reference to equations (1) to (6) and FIG. 7.

A unit vector, \hat{v}, in the direction θ, from the camera viewpoint 31, is calculated using the formula:

\hat{v}=(cos(el)sin(az),cos(el)cos(az),sin(el)) (1)

where el is the elevation and az is the azimuth associated with the pixel 34 from the camera viewpoint 31. That is, el and az are the elevation and azimuth of the direction θ.

A vector depth_pos, describing the direction and distance of the point 35 in the scene 33 represented by the pixel 34 from the camera viewpoint 31 is calculated using the formula:

depth_pos=d*(cos(el)sin(az), cos(el)cos(az), sin(el)) (2)

where, d is the distance of the point 35 in the scene 33 represented by the pixel 34 from the camera viewpoint 31, determined using the depth map as described above. The vector depth_pos is illustrated in FIG. 7 by a line 40.

A vector, new_pos, describing a new position in the fixed coordinate system when originating from the camera viewpoint 31, is calculated using the formula:

new_pos=eye_offset+|depth_pos−eye_offset|*\hat{v} (3)

where eye_offset is a vector describing the offset of the chosen viewpoint 36 from the camera viewpoint 31. It will be appreciated that |depth_pos−eye_offset| is the distance of a point given by depth_pos from a point given by eye_offset when both depth_pos and eye_offset originate from a common origin. The vector (depth_pos−eye_offset) is indicated by a line 41 between the point 36 and the point 35.

It will further be appreciated that the value of |depth_pos−eye_offset| determines a point at which the vector new_pos intersects the line 37 when the vector new_pos originates from the camera viewpoint 31. If the vector new_pos intersects the line 37 at the point where the line 37 intersects the scene (i.e. point 38), the vector new_pos will pass through the desired pixel 39.

As it is unknown at which point the line 37 intersects the scene 33, it is determined whether the pixel of the input image 32 in the direction of new_pos has a corresponding distance in the depth map equal to |new_pos|. If not, a new value of new_pos is calculated, which, from the camera position 31, intersects the scene 33 at a new location. A first value of new_pos is indicated by a line 42, which intersects the line 37 at a point 43, and intersects the scene 33 at a point 44. For a smoothly-varying depth map, subsequent iterations of new_pos would be expected to provide a better estimate of the intersection of the line 37 with the scene 33. That is, subsequent iterations of new_pos would be expected to intersect the line 37 nearer to the point 38.

In more detail, the values of az and el are recalculated as the azimuth and elevation of new_pos using equations (3) and (4):

$$\begin{matrix}az = arctan ( \frac{new\_pos \cdot x}{new\_pos \cdot y} ) & ( 4 ) \\ el = arcsin ( \frac{new\_pos \cdot z}{new\_pos \cdot y} ) & ( 5 )\end{matrix}$$

The new values of az and el are then used to as lookup values in the depth map to determine the depth, d, from the camera viewpoint 31, corresponding to the pixel in the input image at the calculated azimuth and elevation, as shown at equation (6):

d=dlookup(az,el) (6)

If d (as calculated at equation (6)) is equal to |new _pos| then the correct pixel, 39, has been identified. When the correct pixel in the input image is identified, a pixel having the same coordinates in the output image as pixel 34 in the input image, is given the value of the pixel which is in the direction of new_pos, that is, the pixel 39 in FIG. 7.

If d (as calculated at equation (6)) is not equal to |new_pos|, equations (2) to (6) are iterated. In each iteration, the values of el, az and d calculated at equations (4), (5) and (6) of one iteration are input into equation (2) of the next iteration to determine a new value for the vector depth_pos

By iterating through equations (2) to (6), the difference between d and |new_pos| will tend towards zero provided that the depth function is sufficiently smooth and the distance between the camera position 31 and the view position 36 is sufficiently small. Given that the above calculations are performed for each pixel in an image, in real-time, a suitable stop condition may be applied to the iterations of equations (2) to (6). For example, equations (2) to (6) may iterate up to four times.

In the present embodiment, equations (1) to (6) are performed in a pixel-shader of a renderer, so that the described processing is able to run on most modern computer graphics hardware. The present embodiment does not require the final estimate for the point 38 to be exact, instead performing a set number of iterations, determined by the performance capabilities of the hardware it uses.

The above process is performed for each pixel in the input view to generate the output image, showing the scene 33 from the chosen viewpoint in the view direction θ.

Two sets of image data may be acquired, the image data being acquired at a respective spatial position, and the spatial positions being arranged laterally relative to the chosen viewpoint. In such a case, the processing described above is performed on each of the two sets of image data, thereby generating two output images. The two output images are then combined to generate a single output image for presentation to a user. The combination of the two generated output images can be a weighted average, wherein the weighting applied to an output image is dependent upon the camera viewpoint of the obtained image from which that output image is generated, in relation to the chosen viewpoint. That is, an output image generated from an obtained image which was acquired at a location near to the chosen viewpoint would be weighted more heavily than an output image generated from an obtained image which was acquired at a location further away from the chosen viewpoint.

FIG. 8 shows an output image generated from the input image of FIG. 5 using the processing described above. It can be seen that the input image of FIG. 5 centres on a left-hand side of a road, while the output image of FIG. 8 centres on the centre of the road.

As has been explained above, image data may be acquired from a plurality of locations. Typically, each point in a scene will appear in more than one set of acquired image data. Each point in the scene would be expected to appear analogously in each set of acquired image data. That is, each point in a scene would be expected to have a similar (although not necessarily identical) pixel value in each set of image data in which it is represented.

However where a moving object is captured in one set of image data but not in another set of image data, that moving object may obscure a part of the scene in one of the sets of image data. Such moving objects could include, for example, moving vehicles or moving people or animals. Such moving objects may not be detected by the active scanning device 15 given that the moving object may have moved between a time at which an image is captured and a time at which the position data is acquired. This can create undesirable results where a plurality of sets of image data are used to generate an output image, because a particular point in the scene may have quite different pixel values in the two sets of image data. As such, it is desirable to identify objects which appear in one set of image data representing a particular part of a scene but which do not appear in another set of image data representing the same part of the scene.

The above objective can be achieved by determining for each pixel in acquired image data a corresponding point in the scene which is represented by that pixel, as indicated by the position data. Pixels representing that point in other sets of image data can be identified. Where a pixel value of a pixel in one set of image data representing that point varies greatly from pixel values of two or more pixels representing that location in other sets of image data, it can be deduced that the different pixel value is attributable to some artefact (e.g. a moving object) which should not be included in the output image. As such, the different pixel value can be replaced by a pixel value based upon the pixel values of the two or more pixels representing that location in the other sets of image data. For example the different pixel value can be replaced by one or other of pixel values of the two or more pixels representing the location in the other sets of image data, or alternatively can be replaced by an average of the relevant pixel values in the other sets of iamge data. This processing can be carried out as a pre-processing operation on the acquired image data so as to remove artefacts from the image data before processing to generate an output image.

Further manipulation of the images may be carried out, such as removal of a shadow of the data acquisition vehicle 13 and any parts of the data acquisition vehicle 13 in the field of view of the image acquisition device.

It will be appreciated that occlusion may occur where some features of the environment of interest, which are not seen in an image obtained at a camera view point because they are behind other features in the environment of interest along the same line of sight, would be seen from the chosen viewpoint. FIGS. 9A and 9B illustrate the problem. The dark areas 45 of the output image (FIG. 9B) were occluded in the input view (FIG. 9A).

Occlusion can be detected by finding where subsequent iterations of the depth texture lookup at equation (6) produce sufficiently different distance values, in particular where the distance becomes significantly larger between iterations.

There are various possible approaches to alleviating occlusion. One suitable approach is to use the pixel having the furthest corresponding depth measured in the iterations of equations (1) to (6). This has the effect of stretching the image from adjacent areas to the occluded area, which works well for low-detail surfaces such as grass, tarmac etc. FIGS. 10A and 10B, respectively show an input image and a manipulation of the input image to illustrate how this works in practice. As the viewpoint changes, more of the tarmac between the “Start” sign 46 and the white barrier 47 should be revealed. The image is filled in with data from the furthest distance in the view direction, which in the images of FIG. 10A is a central area of tarmac 48.

Driving games are often in the form of a race involving other vehicles. Where the present invention is utilised to provide a driving game, other vehicles may be photographed and representations of those vehicles added to the output image presented to a user. For example, driving games provided by embodiments of the present invention may incorporate vehicles whose positions correspond to those of real vehicles in an actual race, which may be occurring in real-time. A user may drive around a virtual circuit while a real race takes place, and see representations of the real vehicles in their actual positions on the track while doing so. These positions may be determined by positioning systems on board the real cars, and transmitted to the user over a network, for example the Internet.

It will be appreciated that where representations of real cars presented to a user in a driving game, it is not desirable to show representation of the user's car and representations of real cars in the same spatial location in the track. That is, cars should not appear to be “on top” of one another.

The present invention provides a simulation of a real world environment in which the images presented to the user are based on real photographs instead of conventional computer graphics. While it has been described above with particular reference to driving games and simulations, it may of course be used in implementing real world simulations of other types.

It will further be appreciated that while embodiments of the invention described above have focused on applications involving a linear track, embodiments of the present may be applied more generally. For example, where the present invention is not to be used with a linear track, data may be captured in a grid pattern. It will further be appreciated that while, in the described embodiments, the height of the viewpoint remains constant, data may be captured from a range of heights, thereby facilitating movement of the virtual viewpoint in three dimensions.

Aspects of the present invention can be implemented in any convenient form. For example, the invention may be implemented by appropriate computer programs which may be carried out appropriate carrier media which may be tangible carrier media (e.g. disks) or intangible carrier media (e.g. communications signals). Aspects of the invention may also be implemented using suitable apparatus which may take the form of programmable computers running computer programs arranged to implement the invention.

1-34. (canceled)

35. A method of generating output image data representing a view from a specified spatial position in a real physical environment, the method comprising:
receiving data identifying said spatial position in said physical environment;
receiving image data, the image data having been acquired using a first sensing modality;
receiving positional data indicating positions of a plurality of objects in said real physical environment, said positional data having been acquired using a second sensing modality; and
processing at least part of said received image data based upon said positional data and said data representing said specified spatial position to generate said output image data.

36. A method according to claim 35, wherein said second sensing modality comprises active sensing and said first sensing modality comprises passive sensing.

37. A method according to claim 35, wherein said received image data comprises a generally spherical surface of image data.

38. A method according to claim 35, further comprising:
receiving a view direction;
selecting a part of said received image data said part representing a field of view based upon said view direction;
wherein said at least part of said image data is said selected part of said image data.

39. A method according to claim 35, wherein said received image data is associated with a known spatial location from which said image data was acquired.

40. A method according to claim 39, wherein processing at least part of said received image data based upon said positional data and said data representing said spatial position to generate said output image data comprises:
generating a depth map from said positional data said depth map comprising a plurality of distance values, each of said distance values representing a distance from said known spatial location to a point in said real physical environment.

41. A method according to claim 40, wherein said at least part of said image data comprises a plurality of pixels, the value of each pixel representing a point in the real physical environment visible from said known spatial location; and
wherein for a particular pixel in said plurality of pixels, a corresponding depth value in said plurality of distance values represents a distance from said known spatial location to the point in the real physical environment represented by that pixel.

42. A method according to claim 41, wherein:
said plurality of pixels are arranged in a pixel matrix, each element of the pixel matrix having associated coordinates;
said plurality of depth values are arranged in a depth matrix, each element of the depth matrix having associated coordinates; and
a depth value corresponding to a particular pixel located at particular coordinates in said pixel matrix is located at said particular coordinates in said depth matrix.

43. A method according to claim 40, wherein processing at least part of said received image comprises, for a first pixel in said at least part of said image data;
using said depth map to determine a first vector from said known spatial location to a point in said real physical environment represented by said first pixel;
processing said first vector to determine a second vector from said known spatial location wherein a direction of said second vector is associated with a second pixel in said at least part of said received image; and
setting a value of a third pixel in said output image data based upon the value of said second pixel, said third pixel and said first pixel having corresponding coordinates in said output image data and said at least part of said received image data respectively.

44. A method according to claim 42, further comprising:
iteratively determining a plurality of second vectors from said known spatial location wherein respective directions of each of said plurality of second vectors is associated with a respective second pixel in said at least part of said received image; and
setting the value of said third pixel comprises setting the value of said third pixel based upon the value of one of said respective second pixels.

45. A method according to claim 35, wherein said received image data is selected from a plurality of sets of image data, the selection being based upon said received spatial location.

46. A method according to claim 45, wherein said plurality of sets of image data comprises images of said real physical environment acquired at a first plurality of spatial locations.

47. A method according to claim 46, wherein each of said plurality of sets of image data is associated with a respective known spatial location from which that image was acquired.

48. A method according to claim 39, wherein said known location is determined from a time at which that image was acquired by an image acquisition device and a spatial location associated with said image acquisition device at said time.

49. A method according to claim 35, wherein said positional data is generated from a plurality of depth maps, each of said plurality of depth maps acquired by scanning said real physical environment at respective ones of a second plurality of spatial locations.

50. A method according to claim 46, wherein said first plurality of locations are located along a track in said real physical environment.

51. A method according to claim 35, wherein said positional data is acquired using a Light Detecting And Ranging device.

52. Apparatus for generating output image data representing a view from a specified spatial position in a real physical environment, the apparatus comprising:
means for receiving data identifying said spatial position in said physical environment;
means for receiving image data, the image data having been acquired using a first sensing modality;
means for receiving positional data indicating positions of a plurality of objects in said real physical environment, said positional data having been acquired using a second sensing modality; and
means for processing at least part of said received image data based upon said positional data and said data representing said specified spatial position to generate said output image data.

53. A computer apparatus for generating output image data representing a view from a specified spatial position in a real physical environment comprising:
a memory storing processor readable instructions; and
a processor arranged to read and execute instructions stored in said memory;
wherein said processor readable instructions comprise instructions arranged to control the computer to carry out a method according to claim 35.

54. A method of acquiring data from a physical environment, the method comprising:
acquiring, from said physical environment, image data using a first sensing modality;
acquiring, from said physical environment, positional data indicating positions of a plurality of objects in said physical environment using a second sensing modality;
wherein said image data and said positional data have associated location data indicating a location in said physical environment from which said respective data was acquired so as to allow said image data and said positional data to be used together to generate modified image data.

55. A method according to claim 54 wherein said image data and said positional data are configured to allow generation of image data from a specified location in said physical environment.

56. A method according to claim 54, wherein acquiring positional data comprises:
scanning said physical environment at a plurality of locations to acquire a plurality of depth maps, each depth map indicating the distance of objects in the physical environment from the location at which the depth map is acquired; and
processing said plurality of depth maps to create said positional data.

57. Apparatus for acquiring data from a physical environment, the method comprising:
means for acquiring, from said physical environment, image data using a first sensing modality;
means for acquiring, from said physical environment, positional data indicating positions of a plurality of objects in said physical environment using a second sensing modality;
wherein said image data and said positional data have associated location data indicating a location in said physical environment from which said respective data was acquired so as to allow said image data and said positional data to be used together to generate modified image data.

58. A computer apparatus for acquiring data from a physical environment comprising:
a memory storing processor readable instructions; and
a processor arranged to read and execute instructions stored in said memory;
wherein said processor readable instructions comprise instructions arranged to control the computer to carry out a method according to claim 20.

59. A computer program comprising computer readable instructions configured to cause a computer to carry out a method according to claim 35 or 54.

60. A computer readable medium carrying a computer program according to claim 59.

61. A method for processing a plurality of images of a scene, the method comprising:
selecting a first pixel of a first image, said first pixel having a first pixel value;
identifying a point in said scene represented by said first pixel;
identifying a second pixel representing said point in a second image, said second pixel having a second pixel value;
identifying a third pixel representing said point in a third image, said third pixel having a third pixel value;
determining whether each of said first pixel value, said second pixel value and said third pixel value satisfy a predetermined criterion; and
if one of said first pixel value, said second pixel value and said third pixel value do not satisfy said predetermined criterion, modifying said one of said pixel values based upon values of others of said pixel values.

62. A method according to claim 61, wherein said predetermined criterion specifies allowable variation between said first, second and third pixel values.

63. A method according to claim 61, wherein modifying said one of said pixel values based upon values of others of said pixel values comprises replacing said one of said pixel values with a pixel value based upon said others of said pixel values.

64. A method according to claim 63, wherein replacing said one of said pixel values with a pixel value based upon said others of said pixel values comprises replacing said one of said pixel values with an average of said others of said pixel values.

65. A method according to claim 35 wherein processing at least part of said received image data based upon said positional data and said data representing said specified spatial position to generate said output image data further comprises processing said received image data using a method according to any one of claims 61 to 64.

66. A computer apparatus comprising:
a memory storing processor readable instructions; and
a processor arranged to read and execute instructions stored in said memory;
wherein said processor readable instructions comprise instructions arranged to control the computer to carry out a method according to claim 61.

67. A computer program comprising computer readable instructions configured to cause a computer to carry out a method according to claim 61.

68. A computer readable medium carrying a computer program according to claim 67.
